(19) United States
(12) Patent Application Publication
(10) Pub. No.: US 2023/0380470 A1
(43) Pub. Date: Nov. 30, 2023

(54) FORMULATIONS FOR PREBIOTIC HARD CAPSULES

(71) Applicant: AgriFiber Solutions, LLC, Mundelein, IL (US)

(72) Inventors: Edward C. Deehan, Mundelein, IL (US); Jacob Chegeni, Mundelein, IL (US); Rodger Jonas, Mundelein, IL (US)

(21) Appl. No.: 18/202,777

(22) Filed: May 26, 2023

Related U.S. Application Data
(60) Provisional application No. 63/346,716, filed on May 27, 2022.

(51) Int. Cl. A23L 33/135; A23P 20/10

(52) U.S. Cl. CPC A23L 33/135; A23P 20/105

(57) ABSTRACT

Hard capsule compositions comprising prebiotic ingredients including arabinoxylan, as well as methods for making the compositions, are disclosed. The disclosure includes products and method for making a clean-label, natural film-forming material that is sustainably produced from upcycled agricultural waste streams. Specifically, the disclosure describes products and methods for making prebiotic arabinoxylan hard capsules for vegan, clean-label, upcycled alternatives to gelatin hard capsules.

### CROSS-REFERENCE TO RELATED APPLICATIONS

This application claims priority to U.S. Provisional Application No. 63/346,716, filed May 27, 2022, the disclosure of which is incorporated by reference herein in its entirety.

### TECHNICAL FIELD

The present disclosure relates generally to the field of hard capsules for oral dosages, and more specifically to formulations and methods of processing hard capsules comprising prebiotic compounds.

### BACKGROUND

Hydroxypropyl methylcellulose (HPMC) alone, or in combination with a gelling agent like kappa-carrageen or gellan gum, is a commonly-used plant-based, vegan alternative to gelatin for manufacturing hard capsules used for oral dosages. Other vegan alternatives such as pullulan and starch are also used, but to a lesser extent.

One drawback of the manufacturing of HPMC hard capsules is that it requires either the addition of an undesirable gelling agent, as HPMC does not gel at room temperature, or a modification to the conventional manufacturing process used for gelatin hard capsules, which adds cost. In contrast to gelatin hard capsules, which involve chemical processing wherein pins held at room temperature are dipped into a heated gelatin solution, HPMC hard capsules that lack gelling agents instead require chemical processing that involves dipping heated pins into an HPMC solution held at room temperature. But the addition of gelling agents may introduce other drawbacks as gelling agents can delay the dissolution of HPMC hard capsules due to the addition of cations and lower pH. Furthermore, while HPMC hard capsules are less sensitive and permeable to moisture, they are more oxygen permeable relative to gelatin hard capsules.

Another drawback of HPMC hard capsules is that HPMC (E464) is produced from chemical modifications of cellulosic material, typically wood-derived cellulose. The gelling agents are also food additives, with kappa-carrageen (E407) isolated from select species of red seaweed and gellan gum (E418)—an exopolysaccharide secreted by the bacterium Sphingomonas elodea.

Pullulan is an exopolysaccharide secreted by the fungus Aureobasidium pullulans. While pullulan is a slowly digestible carbohydrate and a proposed prebiotic, it is a food additive (E1204) and not considered a clean-labeled, natural ingredient. Though pullulan hard capsules are impermeable to oxygen, they are more sensitive than gelatin to low moisture conditions and brittleness. The manufacturing of pullulan hard capsules may also necessitate an undesirable gelling agent to achieve an optimal viscosity and have higher manufacturing costs relative to gelatin.

While starch hard capsules may be considered vegan, clean-label, and natural, one drawback is that they require unconventional equipment for both manufacturing and filling the hard capsules.

Prebiotics are defined by the International Scientific Association for Probiotics and Prebiotics as substrates that are selectively utilized by host microorganisms conferring a health benefit. While there are exceptions, the term “prebiotics” generally refers to non-digestible carbohydrates that are selectively utilized by specific microbes that reside within the gastrointestinal tract. “Upcycling” has also been defined by the Upcycled Food Association as the production of products from agricultural residuals that would otherwise have ended up in a food waste destination. In contrast, the term “clean-label” generally refers to the use of simple ingredients free from food additives, preservatives, or synthetic compounds. For instance, ingredients with Europe-numbers or E-numbers are viewed as being undesirable and are not considered clean-label. E-numbers are the legal names assigned in Europe to individual food additives and are provided on back-of-package ingredient lists instead of more general names (e.g., E330 instead of citric acid). There is increasing consumer demand for foods that are clean-label and sustainable.

Topping et al., (2003) describes the concept of making a capsule with a prebiotic but does not disclose any processes or products that may actually work in practice.

Mishra et al., (2009) describes the use of xyloglucans (a kind of fiber) in hard capsules for the pharmaceutical industry and describes that xyloglucans are prebiotic.

The GRAS Notice for Pullulan (2013) describes the use of pullulan in a hard capsule and also describes pullulan as a prebiotic.

Products that reference that pullulan capsules are “prebiotic-infused” include NutriCaps® (https://www.testolabpro.com/pages/quality; https://www.performancelab.com/pages/quality). Other pullulan cap manufactures, including Lonza, do not mention that their capsules are prebiotic (https://www.capsugel.com/consumer-health-nutrition-products/plantcaps-capsules; https://www.lfacapsulefillers.com/empty-pullulan-capsules-size-00-clear). Again, however, pullulan is considered a food additive and is not clean-label. Further, most companies that market pullulan consider it an excipient or inactive vegan ingredient (e.g., https://www.amazon.com/NaturesPlus-Source-Certified-Organic-Vitamin/dp/B0042DDP44/ref=cm_cr_srp_d_product_top?ie=UTF8 ; https://shop.ora.organic/products/plant-based-probiotics-with-prebiotics-capsules; https://www.heb.com/product-detail/garden-of-life-dr-formulated-probiotics-prostate-shelf-stable-capsules/2063906).

Most of the probiotic and prebiotic capsules on the market are merely mixtures of the probiotics and prebiotics as a fill material of the hard capsule (e.g., https://www.walgreens.com/store/c/mason-natural-probiotic-with-prebiotic-veggie-capsules/ID=300398887-product; https://www.walmart.com/ip/Nature-s-Way-Fortify-Age-50-50-Billion-Daily-Probiotic-Supplement-10-Strains-Digestive-Health-Immune-Support-Colon-Non-GMO-Project-Verified-No-Refrig/982795470?w113=1228&selectedSellerId=0).

Other products use two capsules, the first outer-capsule containing the prebiotic and the second inner-capsule containing the probiotic material (e.g., https://www.capsugel.com/consumer-health-nutrition-products/duocap-capsules;

https://seed.com/daily-synbiotic). Other products may use probiotic and prebiotic together as the fill material, and/or use pullulan without mentioning its prebiotic function.

Overall, there remains a need for a plant-based, vegan alternative to gelatin that also has prebiotic, upcycled, and clean-label attributes.

### BRIEF DESCRIPTION OF THE DRAWINGS

Non-limiting and non-exhaustive embodiments are described in reference to the following drawings. The components in the figures are not necessarily to scale, emphasis instead being placed upon illustrating the principles of the disclosure. In the drawings, like reference numerals refer to like parts through all the various figures unless otherwise specified.

For a better understanding of the present disclosure, a reference will be made to the following detailed description, which is to be read in association with the accompanying drawings, wherein:

FIG. 1 shows a flow chart of an embodiment of a hard capsule shell manufacturing process.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not required. It will also be understood that the terms and expressions used herein are to be defined with respect to their corresponding respective areas of inquiry and study except where specific meanings have otherwise been set forth herein.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In some embodiments, the disclosure describes a clean-label prebiotic hard capsule. The hard capsule compositions may comprise prebiotic ingredients including arabinoxylan, as well as methods for making the compositions. The disclosure describes a product and method for making a clean-label, natural film-forming material that may be sustainably produced from upcycled agricultural waste streams. In some embodiments, the disclosure describes a product and method for making prebiotic arabinoxylan hard capsules that may be vegan, clean-label, upcycled alternatives to gelatin hard capsules.

### DETAILED DESCRIPTION

In some embodiments, the disclosure describes a clean-label prebiotic hard capsule and methods for producing a clean-label prebiotic hard capsule that may be used in various applications, such as oral dosages of supplements, medications, etc. In some embodiments, the disclosure may address several problems related to traditional hard capsules. Most (˜75%) traditional hard capsules manufactured utilize gelatin, derived from skin, connective tissue, and bones of swine, cattle, and, to a lesser degree, fish, as the primary ingredient, and thus are not vegan. Additionally, traditional gelatin hard capsules have known shortcomings. For example, gelatin hard capsules are sensitive and permeable to moisture. Gelatin hard capsules also require a relatively high moisture content of around 12 to 16% to prevent brittleness and, as a result, allow the transmission of water vapor to the fill material. This may make them incompatible with hygroscopic materials and materials prone to hydrolysis. Traditional gelatin hard capsules may also undergo cross-linking with age and when exposed to improper storage conditions, such as high temperature, high moisture, and UV radiation. Further, gelatin hard capsules are typically animal-based, carry concerns of transmissible spongiform encephalopathy when derived from cattle, and cannot be kosher or halal when derived from swine. Accordingly, plant-based, vegan alternatives to gelatin may be needed to meet certain religious, cultural, health, and personal preferences.

Another problem with traditional hard capsules relates to probiotic supplements. When probiotics are provided as the fill material in hard capsules, the prebiotic that selectively promotes the growth of the probiotic is often not provided therewith. Prebiotics are not typically provided as part of the fill material in hard capsules for several reasons, such as limited fill space and concerns of high-water activity. The hard capsule itself has not traditionally been utilized as a source of prebiotic material.

In some embodiments, the disclosure describes using soluble arabinoxylan ingredients as hard capsule excipients. Such embodiments may improve upon the drawbacks of traditional hard capsules at least because they may provide a clean-label, natural film-forming material that may be sustainably produced from upcycled agricultural waste streams. In some embodiments, the disclosure may, therefore, provide a vegan, clean-label, upcycled alternative to gelatin hard capsules.

Furthermore, soluble arabinoxylan ingredients may be favorably fermented by gut microbes and maybe prebiotic. Specifically, the soluble arabinoxylan ingredient has been shown in a published clinical study to selectively promote the growth of Bifidobacterium longum, a commonly used and putative health-promoting probiotic. In a study published in Microbiome (2020) 8:118, Nguyen et al. found implications for the targeted use of arabinoxylan to modulate the gut microbiota for improved health. Probiotic treatments with Bifidobacterium longum strains were shown previously to be health-promoting in a variety of contexts including gastrointestinal, immunological (e.g., anti-allergy and anti-inflammatory), and psychological (e.g., depression and anxiety disorders). This scientific research supports the use of arabinoxylan in synbiotic applications with Bifidobacterium longum and other bacterial strains. But HPMC and the gelling agents often used therewith are not sustainably produced from upcycled agricultural waste streams, are not considered clean-label, natural ingredients (i.e., they have E-numbers), and are not fermented by gut microbes, and are not prebiotics. It would be advantageous to develop a product and method for producing vegan, clean-label, and natural prebiotic hard capsules for nutraceutical, medical, and health-related purposes.

Accordingly, in some embodiments, the disclosure describes the first prebiotic hard capsule used to develop synergistic, synbiotic products where the excipient is prebiotic, and the fill material is a probiotic. In some embodiments, the hard capsules may serve as the prebiotic for the probiotic fill material.

Typically, hard capsules have been considered to be an inactive vehicle for active fill materials. In some embodiments of the disclosure, the hard capsule may provide an active prebiotic vehicle for active fill materials. Accordingly, in some embodiments, the disclosure describes systems, methods, and products related to vegan, clean-label, prebiotic hard capsules from upcycled, soluble ingredients, such as arabinoxylan.

In some embodiments, the present disclosure describes both characteristics of developed arabinoxylan hard capsules, and specific processing conditions by which the arabinoxylan hard capsules may be produced. In some embodiments, the output of the disclosed process may be vegan, clean-label, upcycled hard capsules that may, in some embodiments, encapsulate probiotics and other nutraceutical ingredients for use as supplements.

In another embodiment, vegan hard capsules may also be non-GMO, gluten-free, kosher, and/or halal certified.

In another embodiment, the hard capsule formulations may contain varying percentages of arabinoxylan. In some embodiments, the disclosure provides a unique composition of matter embodied by hard capsules that may comprise prebiotics, including arabinoxylan, and/or a unique composition of matter embodied by hard capsules that may comprise prebiotics including arabinoxylan plus a gelling agent, such as carrageenan or gellan gum, and a co-gelling agent, such as calcium chloride or potassium chloride.

In some embodiments, conventional manufacturing processes used for gelatin hard capsules may be applicable for the manufacturing of arabinoxylan hard capsules. In some embodiments, the disclosure describes manufacturing processes that may be specially tailored to produce the disclosed arabinoxylan hard capsules. In other embodiments, the arabinoxylan hard capsules may be produced from upcycled agricultural waste streams and may be sustainable.

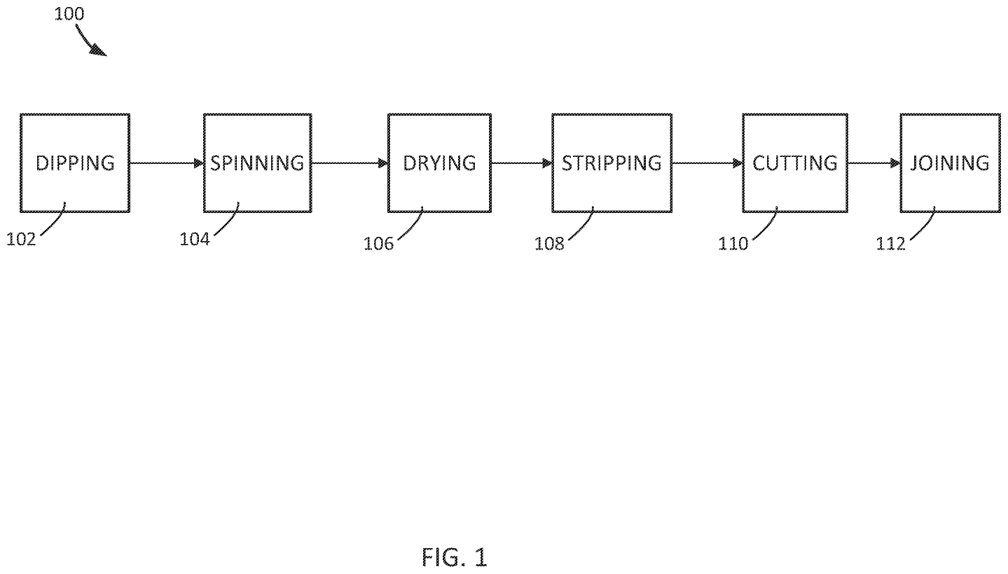

FIG. 1 is a flow chart representing one embodiment of a process 100 for producing the prebiotic hard capsules described herein, which may be specifically arabinoxylan hard capsules. In some embodiments, at 102, pins may be dipped into a dipping bath filled with a prebiotic gel, such as an arabinoxylan gel. Upon removal from the dipping bath, at 104, the pins may be rotated or spun to evenly disperse the prebiotic gel across the surface of the pin. At 106, the pins may be subjected to drying to form a substantially dry prebiotic shell. At 108, the resulting prebiotic hard capsule shell may be removed from the pin and cut to a predetermined size at 110, which may be substantially one half or other portion of a hard capsule shell. The cut shell may then be joined together at 112 with an opposing side of the hard capsule shell, which may have been produced by the same process. In some embodiments, potential variables may be controlled including temperature, gel concentration, loss-on-drying target, and the possible use of gelling/co-gelling agents.

In some embodiments, additional optional components may be included in the process, such as adding other prebiotic or non-prebiotic materials. While arabinoxylan has been identified throughout this description, alternative prebiotics may be used in the same manner. Such prebiotics may include inulin, β-glucan, oligosaccharides, resistant starch, and combinations thereof. Non-prebiotic excipients may also be used to develop alternative prebiotic hard capsules. Other optional ingredients include κ-carrageenan, ι-carrageenan, gellan gum, calcium chloride, potassium chloride, and water.

Table 1 shows examples of three different compositions of various arabinoxylan hard capsules. Composition 1 may contain at least about 84% arabinoxylan and no more than about 16% water by percentage weight. Composition 2 may contain at least about 81% arabinoxylan, no more than about 1.5% κ-Carrageenan or ι-Carrageenan, no more than about 1.5% calcium chloride or potassium chloride, and no more than about 16% water by percentage weight. Composition 3 may contain at least about 81% arabinoxylan, no more than about 1.5% gellan gum, no more than about 1.5% calcium chloride or potassium chloride, and no more than about 16% water by percentage weight.

TABLE 1
Example Compositions of Various Arabinoxylan Hard Capsules

| | | _{K}-Carrageenan | | Calcium or | |
|---|---|---|---|---|---|
| | | or | Gellan | Potassium | |
| Composition | Arabinoxylan | _{I}-Carrageenan | Gum | Chloride | Water |
| 1 | >84% | — | — | — | <16% |
| 2 | >81% | <1.5% | — | <1.5% | <16% |
| 3 | >81% | — | <1.5% | <1.5% | <16% |

In view of the disclosure, several advantages may be achieved and other advantageous results may be attained. As various changes could be made in the above products and methods without departing from the scope of the disclosure, it is intended that all matter contained in the above description and shown in the accompanying drawings shall be interpreted as illustrative and not in a limiting sense.

While various embodiments have been described above, it should be understood that such disclosures have been presented by way of example only and are not limiting. Thus, the breadth and scope of the subject methods, products, and systems should not be limited by any of the above-described exemplary embodiments but should be defined only in accordance with the following claims and their equivalents.

Having now fully described the subject methods, products, and systems, it will be understood by those of ordinary skill in the art that the same can be performed within a wide and equivalent range of conditions, formulations, and other parameters without affecting their scope or any embodiment thereof. All cited patents, patent applications, and publications are fully incorporated by reference in their entireties.

What is claimed is:

1. A hard capsule comprising:
a clean-label prebiotic ingredient.

2. The hard capsule of claim 1, wherein the prebiotic ingredient is arabinoxylan.

3. The hard capsule of claim 1 having a composition including at least 84 percent by weight of the prebiotic ingredient.

4. The hard capsule of claim 3, wherein the prebiotic ingredient is arabinoxylan.

5. The hard capsule of claim 4, wherein the composition further includes no more than 16 percent by weight of water.

6. The hard capsule of claim 1 having a composition including:
at least 81 percent by weight of the prebiotic ingredient;
no more than 1.5 percent by weight of one of κ-Carrageenan or ι-Carrageenan; and
no more than 16 percent by weight of water.

7. The hard capsule of claim 6, wherein the prebiotic ingredient is arabinoxylan.

8. The hard capsule of claim 1 having a composition including:
at least 81 percent by weight of the prebiotic ingredient;
no more than 1.5 percent by weight of gellan gum;
no more than 1.5 percent by weight of one of calcium chloride or potassium chloride; and
no more than 16 percent by weight of water.

9. The hard capsule of claim 8, wherein the prebiotic ingredient is arabinoxylan.

10. A method of producing a hard capsule comprising a clean-label prebiotic ingredient.

11. The method of claim 10, wherein said prebiotic ingredient is arabinoxylan.

12. The method of claim 10, wherein the hard capsule has a composition including at least 84 percent by weight of the prebiotic ingredient.

13. The method of claim 12, wherein the prebiotic ingredient is arabinoxylan.

14. The method of claim 13, wherein the composition further includes no more than 16 percent by weight of water.

15. The method of claim 10, wherein the hard capsule has a composition including:
at least 81 percent by weight of the prebiotic ingredient;
no more than 1.5 percent by weight of one of κ-Carrageenan or ι-Carrageenan; and
no more than 16 percent by weight of water.

16. The method of claim 15, wherein the prebiotic ingredient is arabinoxylan.

17. The method of claim 10, wherein the hard capsule has a composition including:
at least 81 percent by weight of the prebiotic ingredient;
no more than 1.5 percent by weight of gellan gum;
no more than 1.5 percent by weight of one of calcium chloride or potassium chloride; and
no more than 16 percent by weight of water.

18. The hard capsule of claim 17, wherein the prebiotic ingredient is arabinoxylan.

19. A method of producing a hard capsule, the method comprising:
dipping one or more pins into a dipping bath of a prebiotic gel;
removing the one or more pins from the dipping bath;
spinning the one or more pins to disperse the prebiotic gel;
allowing the prebiotic gel dispersed on the one or more pins to substantially dry into a prebiotic hard capsule;
removing the prebiotic hard capsule from the one or more pins; and
cutting the prebiotic hard capsule to a predetermined size.

20. The method of claim 19, wherein the prebiotic gel includes arabinoxylan.
